(19) United States
(12) Patent Application Publication
(10) Pub. No.: US 2026/0275601 A1
(43) Pub. Date: Sep. 17, 2026

(54) ELECTRICAL HEATING ELEMENT, AND SOFTENING DEVICE THEREFOR AND CONTROL METHOD

(71) Applicant: GENTHERM GMBH, Odelzhausen (DE)

(72) Inventors: Zhiwu Liu, Langfang (CN); Zhangang Wen, Langfang (CN)

(21) Appl. No.: 19/699,151

(22) Filed: Jun. 5, 2026

Related U.S. Application Data
(63) Continuation of application No. 16/965,698, filed on Jan. 30, 2019, now abandoned.

(30) Foreign Application Priority Data
Jan. 31, 2018 (CN) 201810095694

(51) Int. Cl. D05B 81/00; D05B 35/00; H01R 43/033; H05B 3/06; H05B 3/36; B60N 2/56

(52) U.S. Cl. CPC D05B 81/00; D05B 35/00; H01R 43/033; H05B 3/06; H05B 3/36; B60N 2/56; D05D 2303/40; D05D 2305/26; D10B 2505/12

(57) ABSTRACT

A method of securing an elongate electrical heating element to a carrier of a cushion, the method includes: providing a softening device having a body including a feeding passage, a gas passage, and an open cavity; conveying the electrical heating element through the feeding passage; driving heated air from a heat source through the gas passage and into the open cavity; heating the electrical heating element within the open cavity to a heat softening temperature; conveying the heated electrical heating element to a sewing head of a sewing apparatus; and securing the heated electrical heating element to the carrier with the sewing head to form a bending in the electrical heating element, the bending is configured to be secured on the cushion and is not able to be bent into a straight line or reshaped at room temperature without damaging the outer insulating layer or the electrical heating wire.

### CROSS REFERENCE TO RELATED APPLICATIONS

This application is a continuation of US 16/965,698 filed on July 29, 2020, which is a National Stage Entry of PCT/CN2019/073930 filed January 30, 2019, which claims priority to CN 201810095694.X filed January 31, 2018.

### TECHNICAL FIELD

The present application generally relates to an electrical heating element, especially an apparatus for sewing an electrical heating element, for example an electrical heating metallic wire, used in a heating cushion of a vehicle. The present application also relates to a softening device, for softening the electrical heating element, used in the sewing apparatus, and a control method for controlling the device.

### BACKGROUND ART

In producing a heating cushion of a vehicle, an electrical heating metallic wire is required to be sewn onto a carrier of the vehicle’s cushion in a predefined pattern. The electrical heating metallic wire is usually coated with an insulating skin on its outer surface. In order to improve the heating performance of the vehicle’s heating cushion, the electrical heating metallic wire may be sewn onto the carrier in a pattern of high density. The insulating skin is usually made of a relatively hard material, and may be multiple bent with relatively sharp angles on the carrier. In case that the pattern is very dense, the insulating skin of the electrical heating metallic wire may be broken due to being multiple bent, which thus results in undesired cases like short circuit in operation, reduced product life and so on.

### SUMMARY

The present application is aimed at proposing a device for softening an electrical heating wire coated with a hard insulating skin, as being sewn, so as to ensure that the electrical heating wire is able to be sewn onto a carrier of a heating cushion with the skin being undamaged.

According to one aspect of the present application, an electrical heating element is provided, which comprises an electrical heating wire and an outer insulating layer with which the electrical heating wire is coated, wherein said electrical heating element has a bending that is adapted to be secured on a cushion, and wherein said bending is not able to be bent into a straight line at room temperature without damaging said outer insulating layer or said electrical heating wire.

Optionally, said bending has a bending radius of not greater than 6 mm, preferably between 1 and 6 mm, particular preferably between 4 and 6 mm.

Optionally, the electrical heating element has an outer diameter of less than 1.5 mm; and/or the outer insulating layer has a thickness of between 0.01 and 0.2 mm, preferably between 0.1 and 0.2 mm.

Optionally, the outer insulating layer is made of a polymeric material, preferably PA12 or PES.

Optionally, the electrical heating element has an operating temperature of not greater than 150℃, and said bending is not able to be bent into a straight line at said operating temperature without damaging said outer insulating layer or said electrical heating wire.

According to another aspect of the present application, an electrical heating device, especially an electrical heating cushion, in particular for a vehicle is provided, wherein said electrical heating device comprises a carrier and the previously mentioned electrical heating element secured on said carrier.

Optionally, a bending of said electrical heating element is secured on the carrier by sewing with threads. In a preferred embodiment, the threads are made of polyester.

Optionally, said threads for securing the bending of the electrical heating element have a stitch length of not greater than 2 mm.

According to another aspect of the present application, a softening device by which an outer insulating layer of an elongate electrical heating element to be secured onto a cushion, especially a vehicle seat or rest cushion is able to be softened is provided, wherein the softening device comprises:

a body, wherein the body is provided with a gas passage, a feeding passage, and an open cavity, wherein hot air is able to be driven through the gas passage, and the elongate electrical heating element is able to be conveyed through the feeding passage, wherein the gas passage and the feeding passage are isolated from each other but both of them open into the open cavity, wherein after passing through the feeding passage and the open cavity, the electrical heating element is able to be discharged out of the body, wherein said electrical heating element is able to be heated by said hot air to a heat softening temperature at which said electrical heating element is capable of being formed with a bending to be secured on a carrier of the cushion, such that said bending is not able to be bent into a straight line at room temperature without damaging said outer insulating layer or an electrical heating wire of said electrical heating element.

Optionally, said bending has a bending radius of not greater than 6 mm, preferably between 1 and 6 mm, particular preferably between 4 and 6 mm.

Optionally, the gas passage and the feeding passage are defined within the body.

Optionally, the gas passage comprises a first gas passage section, upstream located, and a second gas passage section, downstream located, and wherein the second gas passage section is substantially parallel to the feeding passage.

Optionally, the softening device comprises a connecting tube by which the electrical heating element discharged out of the body is kept warm.

Optionally, the softening device comprises an outlet connection member releasably installed onto the body, the outlet connection member is provided with a passage cavity through which the electrical heating element passes, and the connecting tube is air-tightly coupled to the passage cavity.

Optionally, the connecting tube comprises a corrugated tube, a length of spiral spring is secured within the corrugated tube adjacent to the passage cavity, and the electrical heating element passes through a hollow interior of the spiral spring.

Optionally, the spiral spring is secured within the corrugated tube in an interference fitting manner.

Optionally, after the outlet connection member is installed in place, the passage cavity is in air-tight communication with the open cavity, and the passage cavity is provided with an internal circumferential side which narrows in a direction far away from the passage cavity.

Optionally, the softening device comprises a heat source which is able to generate the hot air driven through the gas passage.

Optionally, the softening device comprises a temperature sensor for measuring the temperature of the hot air.

According to another aspect of the present application, an apparatus for sewing an elongate electrical heating element having an outer insulating layer onto a cushion, especially a vehicle seat or rest cushion is provided, said apparatus comprising:

a frame;

a feeding device secured relative to the frame;

a sewing head movable relative to the frame; and

a softening device as mentioned previously and installed on the frame, wherein the elongate electrical heating element having the outer insulating layer is fed from the feeding device to the softening device, and, after being softened by the softening device, is received by the sewing head.

According to another aspect of the present application, a method for controlling the softening device as mentioned previously is provided, which comprises:

measuring the temperature of air flowing in the softening device; and

adjusting the air velocity and/or raising or lowering the air temperature based on measuring results.

Optionally, the measured temperature value approaches a given value, the air velocity and/or the air temperature is enabled to decrease.

According to technical means mentioned above, the electrical heating element coated with the hard outer insulating skin can be softened prior to being sewn, such that the electrical heating element can be bent in a relatively complex pattern, i.e. with small radiuses but is not damaged. Furthermore, during the sewing, operation of the sewing head will not be hindered by the softened electrical heating element.

### BRIEF DESCRIPTION OF THE DRAWINGS

The foregoing and other aspects of the present application will be well understood by the following detailed description in combination with the attached drawings. It should be understood that although the drawings might be illustrated in different ratios for clarity, this does not affect understanding to the present application. In the drawings:

FIG. 1 schematically illustrates a simplified diagram of a sewing apparatus, in which a softening device according to one embodiment of the present application is installed to soften an electrical heating element;

FIG. 2a schematically illustrates an outlet connection member of the softening device according to the present application and a connecting tube adapted for the outlet connection member;

FIG. 2b schematically illustrates an exploded view of the outlet connection member and the connecting tube for it; and

FIG. 3 schematically illustrates a flow chart of a control method for controlling the device according to one embodiment of the present application.

### DETAILED DESCRIPTION

The same reference numerals are used to represent those features having the same or similar functions throughout the drawings of the present application.

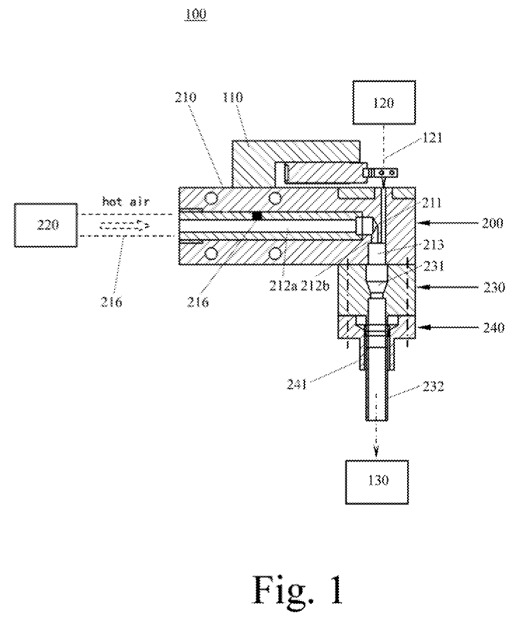

FIG. 1 schematically illustrates a simplified diagram of a sewing apparatus 100, by which an electrical heating element, especially an electrical heating metallic wire can be sewn onto a cushion, especially a vehicle interior’s seat or back cushion. The sewing apparatus 100 generally comprises a stationary frame 110, a feeding device 120 installed on the frame 110, and a sewing head 130 which is movable, as required, relative to the frame 110.

In the present application, the electrical heating element can be an electrical heating elongate body which is coated with an insulating skin. The electrical heating elongate body can be sewn onto a carrier of the cushion by the sewing head 130 such that it can achieve a heating function after being energized. As mentioned in the background art part of the description, for the electrical heating metallic wire coated with the insulating skin, when it is being sewn in a pattern with small corners, the electrical heating metallic wire may be multiple bent, which may result in the relative hard insulating skin being broken and thus the electrical heating metallic wire being exposed.

Therefore, the sewing apparatus 100 is provided with a softening device 200 by which the electrical heating element can be warmed to be softened. According to one embodiment illustrated by FIG. 1, the softening device 200 comprises a body 210 securely installed on the frame 110. A feeding passage 211 is provided within the body 210. The electrical heating elongate element 121 can be conveyed from the feeding device 120 through the feeding passage 211 of the body 210. A gas passage is additionally provided in the body 210. The gas passage is in fluid communication with a heat source 220. For instance, the heat source 220 can be installed on the frame 110 of the sewing apparatus 100. For instance, the heat source 220 can be in airtight communication with the gas passage of the body 210 via a heat-insulated pipeline 221.

The heat source 220 can comprises an electrical heater device (not shown) and an air pump device (not shown). The electrical heater device can be controlled to be energized to produce heat and thus heat air. The heated air is blown by the air pump device through the heat-insulated pipeline 221 into the gas passage of the body 210, and the blowing volume and/or speed can be adjusted as required.

As shown by FIG. 1, the gas passage of the body 210 can comprise a first gas passage section 212a and a second gas passage section 212b. The first gas passage section 212a is generally perpendicular to the feeding passage 211 of the body 210, and the second gas passage section 212b is generally parallel to the feeding passage 211 of the body 210. Viewed from the air’s flowing direction, the first gas passage section 212a is upstream of the second gas passage section 212b.

An open cavity 213 is also provided within the body 210. The gas passage and the feeding passage 211 of the body 210 are isolated from each other such that only at the open cavity 213, the second passage section 212b is in communication with the feeding passage 211. In this way, hot air, after being blown into the gas passage of the body 210, will not be blown directly toward the electrical heating element to let its outer insulating skin be melted due to rapid heating. The hot air passing through the gas passage of the body 210 can be blown, only along a direction parallel to the feeding passage 211, into the open cavity 213. The electrical heating element is heated there such that its outer insulating skin can be gently warmed up and thus softened.

At the open cavity 213, the body 210 is able to be connected to an outlet connection member 230. For instance, the outlet connection member 230 is removably installed on the body 210 using a bolt or other means well known by one ordinary person in the art. A passage cavity 231 is formed in the outlet connection member 230. When the outlet connection member 230 is installed in place on the body 210, the passage cavity 231 is in communication with the open cavity 213. The passage cavity 231 penetrates through the outlet connection member 230. Furthermore, the passage cavity 231 is formed with an inner circumferential section which is tapered. The inner circumferential section is formed so as to taper toward a direction far away from the open cavity 213, such that hot air, after being conveyed there, can be slowed down to prevent “air-back” phenomenon from occurring.

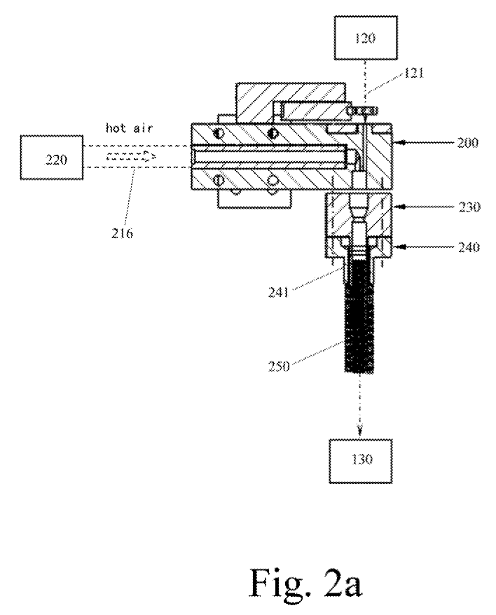

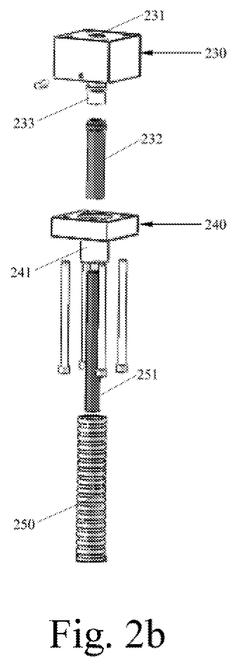

Further as shown by FIG. 2b, a joint 233 extends from a side of the outlet connection member 230 opposite to the body 210. The passage cavity 231 runs through the joint 233. Furthermore, the outlet connection member 230 is equipped with a secondary connection member 240. The secondary connection member 240 is extended with a joint 241, and a through-hole runs through the secondary connection member 240 and its joint 241. Therefore, after the outlet connection member 230 is in contact with the secondary connection member 240, the joint 233 of the outlet connection member 230 can protrude into the through-hole of the secondary connection member 240.

According to one embodiment of the present application, as shown by FIG. 2a, the body 210 of the softening device 200 is coupled to the sewing head 130 of the sewing apparatus 100 with the outlet connection member 230 and the secondary connection member 240 using a connecting tube. It can be seen that in the embodiment of FIG. 2a, four through-holes (or other number is also feasible) are provided in either of the outlet connection member 230 and the secondary connection member 240. Therefore, after the through-holes of the outlet connection member 230 and the secondary connection member 240 are aligned with each other as the members are in contact with each other, respective bolts can be inserted through the respective through-holes and are used to secure the members to the body 210.

Further as shown by FIG. 2b, a ring flange is formed on the joint 233 of the outlet connection member 230 such that a length of silicone pipe or other resilient seal hose 232 can be securely sleeved around the joint 233. In this way, the resilient seal hose 233 is sized such that it can be inserted into the through-hole of the secondary connection member 240 as the joint 233 is being inserted into the through-hole, and the resilient seal hose can at least partially protrude from the joint 241 of the secondary connection member 240. Furthermore, a length of spiral spring 251 can be inserted into the resilient seal hose 232 from an open end opposite to the body 210, and a corrugated tube 250 can be sleeved around the resilient seal hose 232. The spiral spring 251 has an outer diameter which is slightly greater than an inner diameter of the resilient seal hose 232, and the corrugated tube 250 has an inner diameter which is slightly less than an outer diameter of the resilient seal hose 232, such that an interference fit can be established between the spiral spring 251 and the resilient seal hose 232, and between the corrugated tube 250 and the resilient seal hose 232 respectively so as to secure them relative to each other. When the sewing apparatus 100 is operated, the electrical heating element 121, after being softened by the softening device 200, can be continuously conveyed through a hollow interior of the spiral spring 251 and the corrugated tube 250 to arrive at the sewing head 130, and then is sewn by the sewing head 130 onto the carrier of the cushion. Due to the design of the spiral spring 251, the softened electrical heating element 121 is not easy to intertwine in the corrugated tube 250, and use of the corrugated tube 250 can avoid interference with the sewing head 130 as much as possible, which otherwise may affect the sewing procedure.

The corrugated tube 250 can constitute the connecting tube between the body 210 and the sewing head 130, and can be made of a plastic material or a heat-insulated material to ensure that as the softened electrical heating element 121 is being moved in the corrugated tube 250, the softened electrical heating element does not become hardened again because of rapid heat dissipation.

Using the inventive softening device, the electrical heating elongate element 121, for example before arriving at the sewing head 130, can be heated to a heat softening temperature at which the electrical heating element 121 can be secured in a manner of forming bending sections, for instance secured onto the carrier of the cushion by sewing, such that the electrical heating element 121 cannot be straightened at room temperature or a heating operating temperature (for example not greater than 150℃) of the heating element 121 itself if the outer insulating skin or the heating wire is not damaged. In the context of the present application, the heating operating temperature refers to a tolerable temperature of the insulating skin of the heating element 121. In the present application, the heat softening temperature is higher than room temperature or the heating operating temperature of the heating element 121. That is to say, the bending sections of the heating element 121 are shape-cured at room temperature or the heating operating temperature, and they cannot be reshaped if the outer insulating skin or the heating wire is not damaged.

In the embodiment illustrated by FIG. 1, the first gas passage section 212a can be defined by a length of heat-insulated pipe inserted in the body 210. For instance, the length of heat-insulated pipe can be made of a material whose heat-shielding performance is better than the body 210, so as to avoid heat dissipating outward. Optionally, the second gas passage section 212b can be defined by a length of similar heat-insulated pipe inserted in the body 210.

In order to monitor the temperature of hot air conveyed into the softening device 200, a temperature sensor 216 can be arranged in the first gas passage section 212a and/or the second gas passage section 212b. The air temperature measured by the temperature sensor 216 can indirectly reflect the temperature of the outer insulating skin of the electrical heating element 121, and thus the degree to which it is softened. It should be understood by the ordinary person in the art that it is also possible to arrange the temperature sensor 216 in the outlet connection member 230 and/or the secondary connection member 240 to respectively measure the temperature of hot air conveyed through them.

It should be understood by the ordinary person in the art that the inventive softening device 200 is not limited to the embodiments already mentioned by the description or illustrated by the drawings. For instance, in an alternative embodiment, the outlet connection member 230 and/or the secondary connection member 240 can be omitted, and the corrugated tube 250 can be air-tightly connected to the open cavity 213 of the body 210 directly in a manner known by the ordinary person in the art. For instance again, in an alternative embodiment, the first gas passage section 212a and/or the second gas passage section 212b can be provided in the body 210 and isolated from the feeding passage 211 in such a way that the first gas passage section 212a and/or the second gas passage section 212b is at an arbitrary angle relative to the feeding passage 211, as long as it is ensured that hot air in the gas passage will not be blown toward the electrical heating element along a direction perpendicular to the feeding passage 211.

In an alternative embodiment, the gas passage and the feeding passage 211 can be defined by independent heat-insulated pipes arranged outside of the body 210 such that the two pipes converge at the open cavity 213.

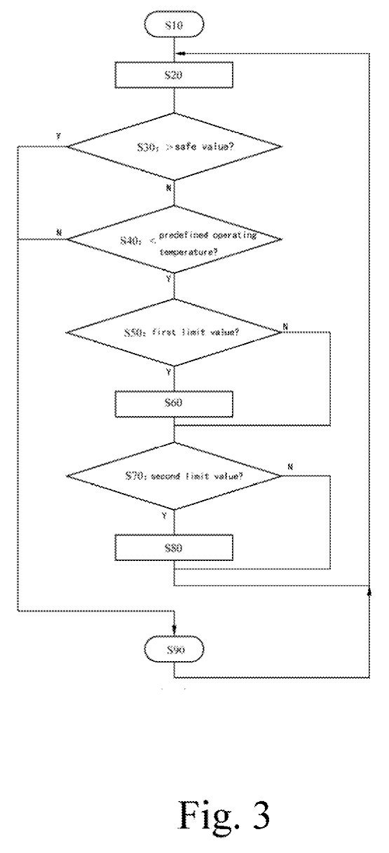

One embodiment of a control method for controlling the softening device according to the present application will be explained by referring to FIG. 3 below. It should be noted that a central process unit is provided in the sewing apparatus 100 to control operations of the feeding device 120, the sewing head 130, the softening device 200 and the heat source 220 respectively, and receive and analyze temperature measurements from the temperature sensor 216. Therefore, the control method mentioned below can be executed in the central process unit.

According to the embodiment of the control method, at step S10, the softening device 200 is powered on. For instance, the electrical heater device and the air pump device of the heat source 220 are energized to operate. In this way, hot air is blown/driven into the gas passage of the softening device 200. Then, at step S20, the air’s temperature is measured by the above-mentioned temperature sensor 216. At step S30, it is judged if a measured temperature value is greater than a predefined safe value. For instance, the safe value can be prescribed as a maximum safe temperature at which the electrical heating element is enabled to be softened when the softening device 200 is operated. That is, if this temperature is exceeded, the electrical heating element might be damaged due to excessive heat. If the judgment result at step S30 is “YES (Y)”, the process goes to step S90 and the softening device 200 is powered off. If the judgment result at step S30 is “NO (N)”, the process goes to step S40. At step S40, it is judged if the measured temperature value is less than a predefined operating temperature. The operating temperature is less than the safe temperature. The predefined operating temperature is set such that when the hot air’s temperature arrives at it, the outer insulating skin of the electrical heating element can be optimally softened to enable the sewing head 130 to produce a relatively complex sewing pattern. If the judgment result at step S40 is “N”, the process goes to step S90 and the softening device 200 is powered off. If the judgment result at step S40 is “Y”, the process goes to step S50.

At step S50, it is judged if an absolute value of the difference between the measured temperature value and the predefined operating temperature (value) arrives at a first limit value. If the judgment result at step S50 is “Y”, the process goes to step S60. If the judgment result at step S50 is “N”, the process goes to step S70. At step S70, it is judged if the absolute value of the difference between the measured temperature value and the predefined operating temperature (value) arrives at a second limit value. If the judgment result at step S70 is “Y”, the process goes to step S80. If the judgment result at step S70 is “N”, the process goes to step S20 and the process continue to circulate.

Step S60 and step S80 relate to temperature adjustment of hot air conveyed in the softening device 200. For instance, in an embodiment, the first limit value and the second limit value can be positive, and the first limit value is less than the second limit value. Furthermore, it can be provided at step S60 that the air pump device of the heat source 220 operates at low power such that hot air conveyed can be slowed down and thus the procedure during which the outer insulating skin of the electrical heating element is heated and softened is slowed down. Further, it can be provided at step S80 that the air pump device of the heat source 220 operates at high power such that the hot air conveyed can be speeded up and thus the procedure during which the outer insulating skin of the electrical heating element is heated and softened is also speeded up. Additionally or alternatively, in the above embodiment, the power of the electrical heater device of the heat source 220 can be adjusted respectively at step S60 and step S80, to change the temperature of the conveyed hot air, and thus the degree to which the outer insulating skin of the electrical heating element is softened by heating. The purpose of setting the first and second limit values is to let the temperature of hot air rise rapidly when the temperature is far away from the predefined operating temperature; and to let the temperature of hot air rise slowly when the temperature approaches to the predefined operating temperature, so as to prevent accumulative hot air from damaging the outer insulating skin of the electrical heating element. It should be understood by the ordinary person in the art that in an alternative embodiment the first limit value can be set to be greater than the second limit value. In this way, operations carried out at steps S60 and S80 can be reversed.

Using technical means already mentioned in the present application, an electrical heating element can be obtained, which comprises an electrical heating wire and an outer insulating layer with which the electrical heating wire is coated, wherein the electrical heating wire has a bending that is adapted to be secured on a cushion, and wherein the bending is not able to be bent into a straight line at room temperature without damaging the outer insulating layer or the electrical heating wire. The bending has a bending radius of not greater than 6 mm, preferably between 1 and 6 mm. The electrical heating element has an outer diameter of less than or equal to 1.5 mm. The outer insulating layer has a thickness of between 0.001 and 0.2 mm, preferably between 0.1 and 0.2 mm. The outer insulating layer is made of a polymeric material, preferably PA12 or PES.

It should be understood by the ordinary person in the art that using the technical means already mentioned in the present application, an electrical heating device, especially an electrical heating cushion, in particular for a vehicle can be obtained, which comprises a carrier and an electrical heating element secured on the carrier, wherein the electrical heating element comprises an electrical heating wire and an outer insulating layer with which the electrical heating wire is coated, wherein the electrical heating wire has a bending that is adapted to be secured on a cushion, and wherein the bending is not able to be bent into a straight line at room temperature without damaging the outer insulating layer or the electrical heating wire. In the context of the present application, the securing of the bending of the electrical heating element on the carrier can be achieved by sewing, wherein the sewing means that the bending of the electrical heating element is secured through the sewing head’s sewing with threads on the carrier. The threads have a stitch length of not greater than 2 mm. In other optional embodiments, the electrical heating element can be secured on the carrier by other suitable means such as bonding.

Although some concrete embodiments of the present application have been explained here, they are given for illustrative purpose only and cannot be thought to constrain the scope of the present application in any way. Furthermore, it should be understood by the ordinary person in the art that the embodiments already described can be combined with each other. Without departing from the spirit and scope of the present application, various alternations, modifications and changes can be thought out.

1. A method of securing an elongate electrical heating element to a carrier of a cushion, the electrical heating element comprising an electrical heating wire and an outer insulating layer, the method comprising:
providing a softening device comprising a body having a feeding passage, a gas passage, and an open cavity;
conveying the electrical heating element through the feeding passage;
driving heated air from a heat source through the gas passage and into the open cavity;
heating the electrical heating element within the open cavity to a heat softening temperature;
conveying the heated electrical heating element to a sewing head of a sewing apparatus; and
securing the heated electrical heating element to the carrier with the sewing head to form a bending in the electrical heating element,
wherein the bending is configured to be secured on the cushion and is not able to be bent into a straight line or reshaped at room temperature without damaging the outer insulating layer or the electrical heating wire.

2. The method of claim 1, wherein the gas passage and the feeding passage are defined within the body and are isolated from one another.

3. The method of claim 1, wherein the gas passage comprises a first gas passage section and a second gas passage section.

4. The method of claim 3, wherein the second gas passage section extends substantially parallel to the feeding passage.

5. The method of claim 4, wherein the first gas passage section is upstream of the second gas passage section.

6. The method of claim 1, wherein the heated air is conveyed into the open cavity along a direction substantially parallel to the feeding passage.

7. The method of claim 1, wherein the heated air is prevented from being blown toward the electrical heating element along a direction perpendicular to the feeding passage.

8. The method of claim 1, wherein the bending has a bending radius of not greater than 6 mm.

9. The method of claim 1, further comprising conveying the heated electrical heating element from the body to the sewing head through a connecting tube while maintaining the electrical heating element in a softened condition.

10. The method of claim 9, wherein the connecting tube thermally insulates the heated electrical heating element to inhibit the electrical heating element from hardening before reaching the sewing head.

11. The method of claim 1, wherein the heated air is slowed before exiting the body.

12. The method of claim 11, wherein the heated air passes through a passage cavity having an internal circumferential side that narrows in a direction away from the open cavity.

13. The method of claim 1, wherein the heated electrical heating element is conveyed through a hollow interior of a spiral spring before reaching the sewing head.

14. The method of claim 13, wherein the spiral spring inhibits intertwining of the heated electrical heating element during conveyance to the sewing head.

15. The method of claim 1, wherein the bending is not able to be bent into a straight line at an operating temperature of the electrical heating element without damaging the outer insulating layer or the electrical heating wire.

16. The method of claim 15, wherein the operating temperature is not greater than 150°C.

17. The method of claim 1, wherein the electrical heating element is heated by hot air flowing parallel to the electrical heating element within the open cavity.

18. The method of claim 1, wherein the electrical heating element is heated without directing hot air toward the electrical heating element along a direction perpendicular to the feeding passage.

19. A method of controlling a softening device configured to soften an elongate electrical heating element having an electrical heating wire and an outer insulating layer, the softening device comprising a heat source having an electrical heater device and an air pump device, and a temperature sensor, the method comprising:
energizing the electrical heater device and the air pump device to drive heated air through the softening device;
measuring, with the temperature sensor, a temperature of the heated air;
determining whether the measured temperature exceeds a predefined safe temperature;
powering off the softening device when the measured temperature exceeds the predefined safe temperature;
determining whether the measured temperature is less than a predefined operating temperature when the measured temperature does not exceed the predefined safe temperature;
determining an absolute value of a difference between the measured temperature and the predefined operating temperature; and
adjusting an air velocity of the heated air and/or a temperature of the heated air based on the absolute value of the difference.

20. The method of claim 19, wherein the air pump device is operated at a first power level when the absolute value of the difference reaches a first limit value; and the air pump device is operated at a second power level greater than the first power level when the absolute value of the difference reaches a second limit value greater than the first limit value.
